(19) United States
(12) Patent Application Publication
(10) Pub. No.: US 2020/0033147 A1
(43) Pub. Date: Jan. 30, 2020

(54) DRIVING MODE AND PATH DETERMINATION METHOD AND SYSTEM OF AUTONOMOUS VEHICLE

(71) Applicant: LG ELECTRONICS INC., Seoul (KR)

(72) Inventor: Dongkyun AHN, Seoul (KR)

(73) Assignee: LG ELECTRONICS INC., Seoul (KR)

(21) Appl. No.: 16/593,920

(22) Filed: Oct. 4, 2019

(30) Foreign Application Priority Data
Aug. 13, 2019 (KR) 10-2019-0098772

(51) Int. Cl. G01C 21/34; G01C 21/36; H04W 4/40; G05D 1/02; G05D 1/00

(52) U.S. Cl. CPC G01C 21/3415; G01C 21/3697; G05D 1/0088; H04W 4/40; G05D 1/0276; G01C 21/3667

(57) ABSTRACT

A method for determining driving mode and path considering a communication environment is provided. In the method for determining the driving mode and path considering the communication environment, the communication environment for the entire section of a path is analyzed in real time using V2X devices disposed on the path to a destination, a path providing the communication environment optimal for autonomous driving is recommended for a vehicle, and thus, a user effectively uses the autonomous driving. The method for determining the driving method and path according to the present invention and an autonomous vehicle using the method are associated with an artificial intelligence module, a robot, an augmented reality (AR) device, a virtual reality (VR) device, and a device related to a 5G service.

### CROSS-REFERENCE TO RELATED APPLICATIONS

Pursuant to 35 U.S.C. § 119(a), this application claims the benefit of earlier filing date and right of priority to Korean Patent Application No. 10-2019-0098772, filed on Aug. 13, 2019, the contents of which are hereby incorporated by reference herein in its entirety.

### BACKGROUND OF THE INVENTION

### Field of the Invention

The present invention relates to a method and a system for determining a driving mode and a path of an autonomous vehicle, and particularly, a method and a system for determining a path and a driving mode for moving an apparatus having a V2X device considering quality of a network communication standard currently serviced in the V2X device using automated vehicle & highway systems to a destination.

### Related Art

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

In automated vehicle & highway systems of the related art, if a user inputs a destination and selects a path to the destination, the automated vehicle & highway systems simply analyze only a traffic condition of the path leading to the destination, determine a path by prioritizing a road having less traffic, and thereafter, perform autonomous driving according to the determination.

Recently, vehicle-to-everything (V2X) communication and device are incorporated into the automated vehicle & highway systems. Accordingly, in the automated vehicle & highway systems, there is an active research for a system of actively identifying an autonomous driving environment through vehicle-to-everything data communication such that a vehicle more safely self-drives in addition to simply collecting and processing information from vehicle-to-vehicle (V2V) communication.

In the vehicle-to-everything (V2X) communication, communication using a millimeter wave (mmWave) of a high frequency band such as 28 GHz or 60 GHz has been discussed in order to transmit a large amount of data more quickly.

In a case of the high frequency band communication such as 28 GHz or 60 GHz, data communication should be performed using LTE or a 5G communication standard service. However, the LTE or 5G communication environment is not uniform for each region, and thus, in the related art, there is a problem that a vehicle equipped with a device for the V2X communication cannot facilitate data communication.

The reason why an LTE or 5G communication environment is not uniform is because line congestion increases or decreases depending on the number of users using the 5G wireless communication network, or data communication with the user terminal is not smooth due to a distance from a base station (BS) installed to provide the 5G wireless communication network.

Accordingly, there is an increasing need for an autonomous vehicle capable of providing a driving mode suitable for a changed communication environment such as the vehicle equipped with the V2X device reminding a user to convert autonomous driving to manual driving when the communication environment is changed.

In addition, in the related art, there are problems that the automated vehicle & highway systems do not provide optimal paths for various driving modes such as a remote driving mode or a cluster driving mode included in an autonomous driving mode when the vehicle equipped with the V2X device tries to perform the autonomous driving, and the automated vehicle & highway systems do not provide a suitable guidance when changes of the driving mode and path are required while the vehicle is driven.

Moreover, in the related art, there are problems that when the driving mode and the path are necessary to be set or changed, the automated vehicle & highway systems set the driving mode without considering quality of the network communication standard currently serviced in the V2X device and do not provide an optimal driving mode to the vehicle being driven.

That is, the driving mode is set without considering a current position communication environment in which the V2X device is located, and thus, in most cases, the V2X device does not smoothly transmit or receive data required for the autonomous driving. Accordingly, a need for a method of changing the driving mode if necessary considering the quality of the network communication standard currently serviced increases for the V2X device being autonomously driven.

### SUMMARY OF THE INVENTION

The present invention aims to solve the above-described needs and/or problems.

An object of the present invention is to provide a method and a system for determining a driving mode and a path capable of providing driving mode and path optimized for a communication environment for each position considering a current position communication environment at which the V2X device is located and a communication environment on a path of the V2X device while the V2X device moves to a destination.

In an aspect, a method for determining a driving mode and a path considering a communication environment is provided. The method includes receiving first data about a communication technology being used by a first device of a plurality of V2X devices and a start position of the first device transmitted from the first device such that a server for determining a driving mode and a path considering the communication environment determines the driving mode and path, calculating a plurality of paths of the first device to a destination, receiving, in real time, second data about a communication technology being used by each device of the plurality of V2X devices distributed on the plurality of paths except for the first device and a current position of each device, analyzing a first communication environment over the entire section for each of the plurality of paths using the second data, providing primarily recommended paths of the plurality of paths in which a numerical value of a result obtained by analyzing the first communication environment is a predetermined numerical value or more, an estimated time of arrival to the destination for each of the primarily recommended paths, and an driving mode corresponding to each primarily recommended path to the first device, and receiving, from the first device, first user information including a path selected by a user and a driving mode corresponding to the selected path. The first communication environment is represented by converting a key performance indicator (KPI) of a communication technology being used by the first device into a numerical value.

The driving mode may include at least one of a manual driving mode, an autonomous driving mode, a cluster driving mode, and a remote driving mode.

The analyzing of the first communication environment may further include associating a path of the plurality of paths satisfying performance requirements based on 3GPP 22.816 with at least one of the autonomous driving mode, the cluster driving mode, and the remote driving mode.

The primarily recommended paths may include at least one of the shortest path and an optimal path, the optimal path may be a path on which the first device is movable from the start position to the destination in at least one of the autonomous driving mode, the cluster driving mode, and the remote driving mode, and the shortest path may indicate a path in which a distance from the start position to the destination is shortest.

The analyzing of the first communication environment may further include updating analysis result data obtained by analyzing the first communication environment and start position information of the first device on an electronic map, and the electronic map may include a first electronic map stored in a database included in the server and a second electronic map stored in an external database.

The analyzing of the first communication environment may further include storing analysis result data obtained by analyzing the first communication environment and start position information of the first device in the database, and the database may include a database included in the server and an external database separated from the server.

The method may further include, after the receiving of the first user information, receiving a current position of the first device and third data for the first communication environment at the current position of the first device, in real time from the first device, checking the second data being received in real time, and reanalyzing, based on the checked second data and third data, a section including the current position of the first device and a first communication environment for a next section to which the first device moves, in a path primarily selected by the user.

The method may further include, after the reanalyzing, generating, when a numerical value for the analysis result of the first communication environment is a predetermined numerical value or less, an alternative path having the first communication environment satisfying performance requirements based on 3GPP 22.816 between the destination and the current position of the first device, determining an estimated time of arrival changed according to the alternative path and an alternative driving mode corresponding to the alternative path, and transmitting the alternative path, the estimated time of arrival changed according to the alternative path, and the alternative driving mode to the first device.

The generating of the alternative path may further include, when the generated alternative path includes only one first alternative path, determining an estimated time of arrival changed according to the first alternative path and a first alternative driving mode corresponding to the first alternative path, requesting, through the first device, to inform the user that only the first alternative path is provided, and transmitting the first alternative path, the estimated time of arrival changed according to the first alternative path, and the first alternative driving mode to the first device.

The determining of the first alternative driving mode corresponding to the first alternative path may further include determining that an operation of the user for the first device is required in a case where the first alternative driving mode is manual driving requiring a manual operation of the user, and requesting, through the first device, the operation of the user for the first device.

The method may further includes, after the reanalyzing, generating, when a numerical value for the analysis result of the first communication environment exceeds a predetermined numerical value, secondarily recommended paths satisfying performance requirements based on 3GPP 22.816 between the destination and the current position of the first device, determining an estimated time of arrival changed for each secondarily recommended path and a secondarily recommend driving mode corresponding to each of the secondarily recommended paths, and transmitting the secondarily recommended paths, the estimated time of arrival changed for each secondarily recommended path, and the secondarily recommended driving mode to the first device.

The communication technology may include 3G, LTE, and 5G communication standards, as a network communication standard being used by the plurality of V2X devices, and the key performance indicator (KPI) may include transmission/reception signal strength indicator, transmission/reception delay time, a packet reception rate, a range between devices, a range between a device and a network, the number of communication line users, and data for communication line congestion.

In another aspect, a method for determining a driving mode and a path considering a communication environment is provided. The method includes transmitting information on a communication technology being used by a first device and information on a starting position and a destination of the first device so that a vehicle including a V2X device communicates with a network or a server using the V2X device as the first device to determine a driving mode and a path, downloading, from the network or the server, primarily recommended paths, an estimated time of arrival to the destination for each of the primarily recommended paths, and a driving mode corresponding to each of the primarily recommended paths, displaying the primarily recommended paths, the estimated time of arrival to the destination for each of the primarily recommended paths, and the driving mode corresponding to each of the primarily recommended paths for a user, receiving an input of first user information including a path selected by the user from among the primarily recommended paths and a driving mode corresponding to the selected path, and transmitting the first user information to the network or the server. Among a plurality of paths from the start position to the destination, the primarily recommended paths are paths indicating that a first communication environment represented by converting a key performance indicator (KPI) of a communication technology being used by the first device into a numerical value is a predetermined numerical value or more.

The downloading of the driving mode corresponding to each of the primarily recommended paths may further include downloading an electronic map updated with information on the first communication environment.

The method may further include, after the transmitting of the first user information to the network or the server, starting the vehicle from the start position to the destination, and transmitting a current position of the first device, the first communication environment at the current position, and third data for the driving mode being used to the server at a predetermined time interval.

The method may further include downloading, from the server, alternative paths, an estimated time of arrival changed for each of the alternative paths, and alternative driving modes, and displaying the alternative paths, the estimated time of arrival changed for each of the alternative paths, and the alternative driving modes, using sound and display.

The method may further include receiving an input of second user information including the alternative path and the alternative driving mode selected by the user, and transmitting the second user information to the server.

The method may further include, after the displaying using the sound and display, outputting a warning sound when the second user information including the alternative path and the alternative driving mode selected by the user is not input for a first time.

The method may further include causing the first device to select one alternative path and one alternative driving mode of the alternative paths and the alternative driving modes when the second user information is not input for a second time after the warning sound is output; and moving the vehicle by a control of the first device.

The method may further include, when one alternative path and one alternative driving mode are included in the alternative paths and the alternative driving modes, displaying the one alternative path and the one alternative driving mode for the user using sound and display.

The method may further include causing the first device to select the one alternative path and the one alternative driving mode, transmitting the one alternative path and the one alternative driving mode selected by the first device to the server, and controlling the first device such that the vehicle moves along the one alternative path and the one alternative driving mode.

The method may further include causing the first device to determine that an operation of the user is required in a case where the one alternative driving mode is a manual driving requiring a manual operation of the user, and causing the first device to request the user to change the mode to a manual driving mode, using a warning sound and display.

The method may further include, after the requesting of the user to change the mode to the manual driving mode, causing the first device to control the vehicle such that the vehicle is stopped at a safe place when an input for selecting the manual driving mode is not detected during a third time. The safe place may include at least one of a parking lot, a road shoulder, a gas station, a car repair shop, a hospital, and a police station included on a path from the current position to the destination.

In still another aspect, a system for determining a driving mode and a path considering a communication environment is provided. The system includes a plurality of V2X devices, and a server configured to communicate with the V2X devices. The server may receive a first communication environment for a communication technology used by a first device of the V2X devices from the first device and the first communication environment from devices other than the first device, analyze the first communication environment over the entire section on a path from a start portion of the first device to a destination thereof, and provide recommend paths, a driving mode corresponding to each recommended path, and an estimated time of arrival to the destination for each recommended path to a user. The first communication environment may be represented by converting a key performance indicator (KPI) of a communication technology being used by the first device into a numerical value.

The server may further include a data analytics configured to analyze the first communication environment and generate the recommended paths, the driving mode, and the estimated time of arrival, a map update configured to update the first communication environment analyzed by the data analytics on an electronic map, an over the air (OTA) configured to transmit the updated electronic map, the recommended paths, the driving mode, and the estimated time of arrival to the first device, and a database configured to store the first communication environment, the recommended paths, the driving mode, and the estimated time of arrival. The communication technology may include 3G, LTE, and 5G communication standards as a network communication standard being used by the plurality of V2X devices, and the key performance indicator (KPI) includes transmission/reception signal strength indicator, transmission/reception delay time, a packet reception rate, a range between devices, a range between a device and a network, the number of communication line users, and data about communication line congestion.

The first device may further include an output unit performing a sound output and display.

The plurality of V2X devices may further include a rod side unit (RSU).

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 is a view showing a vehicle capable of autonomously driving according to an embodiment of the present invention.

FIG. 6 is a control block diagram of the vehicle capable of autonomously driving according to the embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to describe a usage scenario of a user according to an embodiment of the present invention.

FIG. 10 is a conceptual diagram showing a configuration of a system for determining a driving mode and a path considering a communication environment according to an embodiment of the present invention.

FIG. 11 is a conceptual diagram showing a process in which a V2X device performs data communication with a server according to an embodiment of the present invention.

FIG. 12 is a block diagram of a system for determining the driving mode and path considering the communication environment according to an embodiment of the present invention.

FIG. 13 is a flow chart showing a method in which a server determines the driving mode and path considering the communication environment according to an embodiment of the present invention.

FIG. 14 is a diagram showing an example of a method in which the V2X device displays the path and the driving mode selected by a user on a navigation screen according to an embodiment of the present invention.

FIG. 15 is a flow chart showing a method in which the V2X device determines the path and driving mode considering the communication environment according to an embodiment of the present invention.

FIG. 16 is a flow chart showing a process in which the server detects a change in the communication environment and provides changed path and driving mode to the V2X device according to an embodiment of the present invention.

FIG. 17 is a flow chart showing a process in which the V2X device detects the change in the communication environment and provides changed path and driving mode according to an embodiment of the present invention.

FIG. 18 is a diagram showing an example of a method in which the V2X device displays a need to change the path and driving mode on a navigation screen for the user according to an embodiment of the present invention.

FIG. 19 is a diagram showing an example of a method in which the V2X device displays a need to change the path and driving mode on an HUD screen for the user according to an embodiment of the present invention.

FIG. 20 is a flow chart showing a corresponding process of the V2X device according to an input of the user according to an embodiment of the present invention.

FIG. 21 is a flow chart showing a corresponding process of the V2X device in a scenario having one alternative path and one alternative driving mode provided by the server according to an embodiment of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

### A. Example of Block Diagram of UE and 5G Network

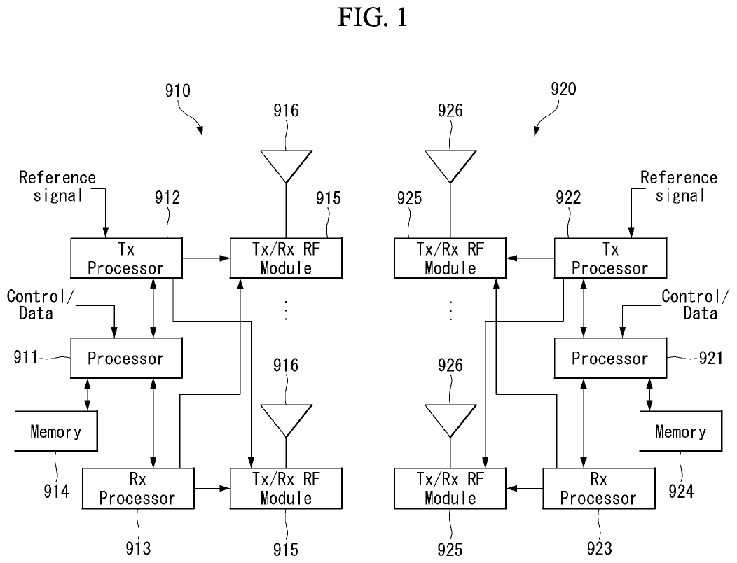

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

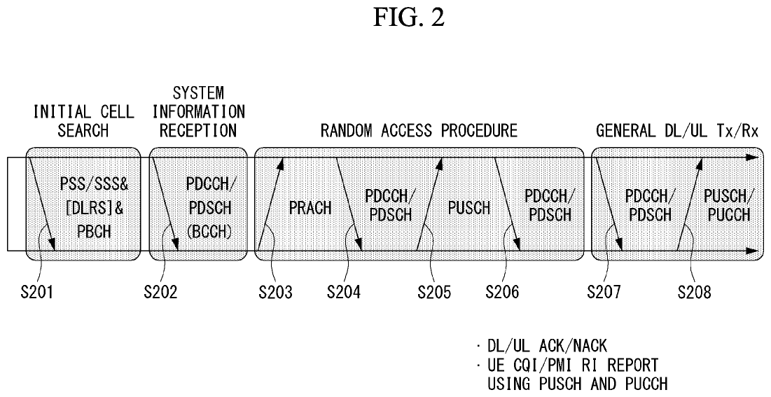

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam management (BM) procedure of 5G communication system

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to “beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

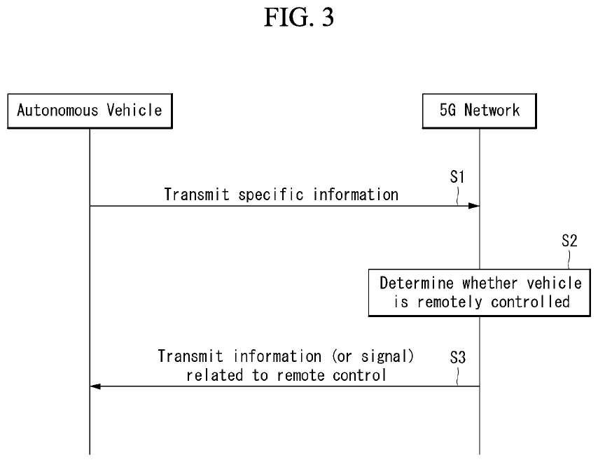

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

### H. Autonomous Driving Operation Between Vehicles Using 5G Communication

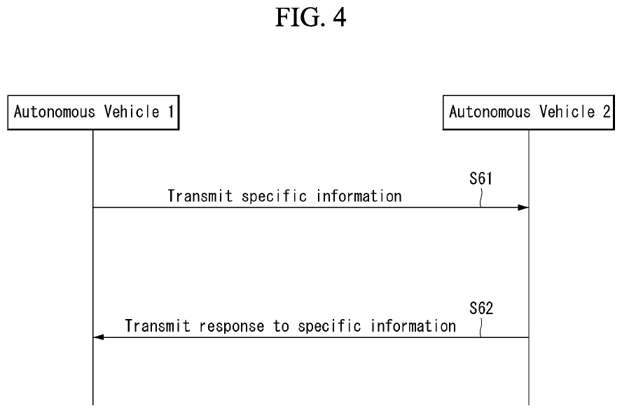

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

### Driving

### (1) Exterior of Vehicle

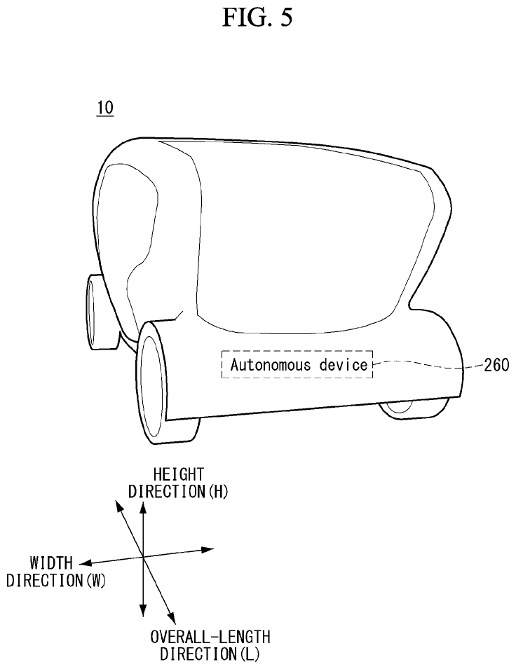

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

### (2) Components of Vehicle

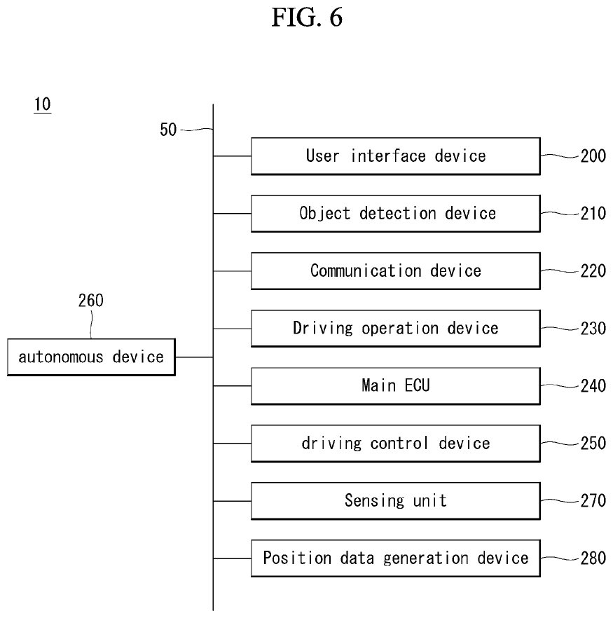

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

### 1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

### 2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

### 2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

### 2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

### 2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

### 3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

### 4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

### 5) Main ECU

The main ECU 240 can control the overall operation of at least one electronic device included in the vehicle 10.

### 6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

### 7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

### 8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

### 9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

### (3) Components of Autonomous Device

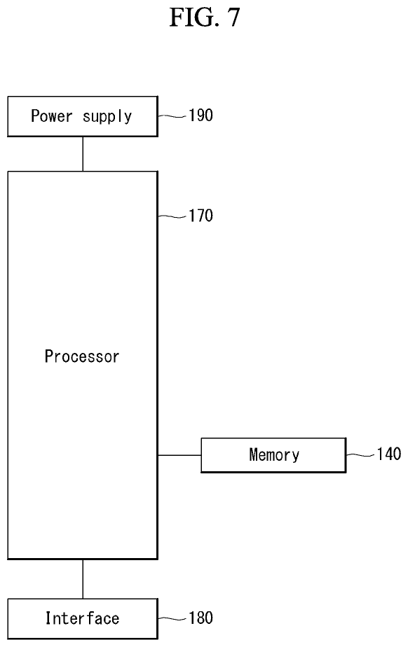

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

### (4) Operation of Autonomous Device

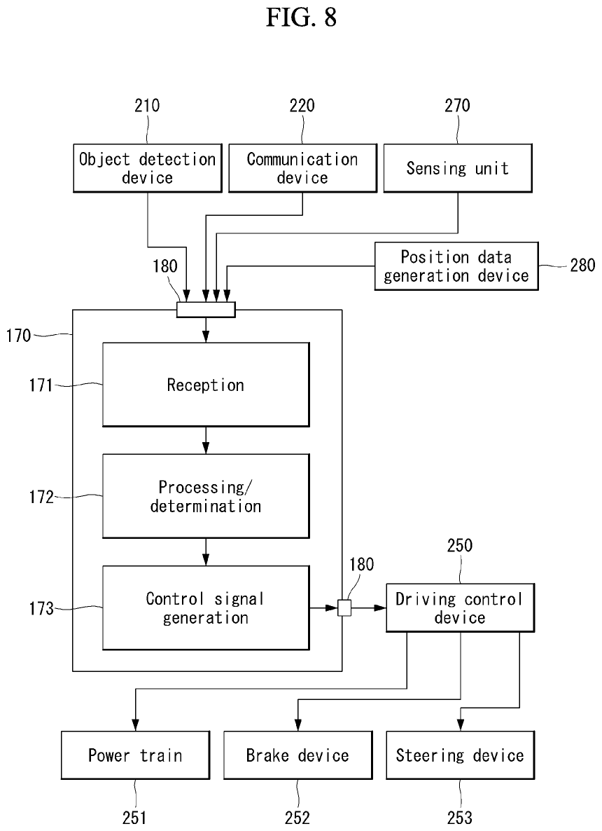

FIG. 8 is a diagram showing a signal flow in an autonomous vehicle according to an embodiment of the present invention.

### 1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

### 2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

### 2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

### 2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

### 2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

### 3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

### Autonomous Vehicle Usage Scenario

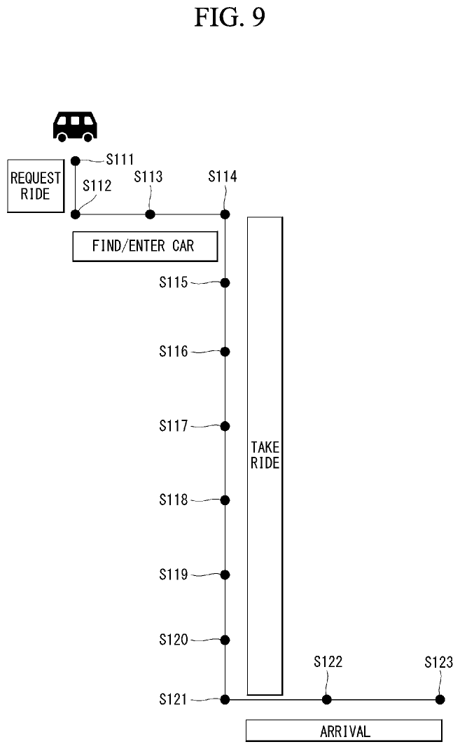

FIG. 9 is a diagram referred to describe a usage scenario of the user according to an embodiment of the present invention.

### 1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

### 2) Cabin Interior Layout Countermeasure Scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

### 3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

### 4) Seat Adjustment Service Scenario

A fourth scenario S114 is a seat adjustment service scenario. The seat system 360 may adjust at least one element of the seat that matches the user based on the acquired physical information.

### 5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

### 6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

### 7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

### 8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

### 9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

### 10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

### 11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

### 12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

### 13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

The above-describe 5G communication technology can be combined with methods proposed in the present invention which will be described later and applied or can complement the methods proposed in the present invention to make technical features of the present invention concrete and clear.

Hereinafter, various embodiments of the present invention will be described in detail with reference to the attached drawings.

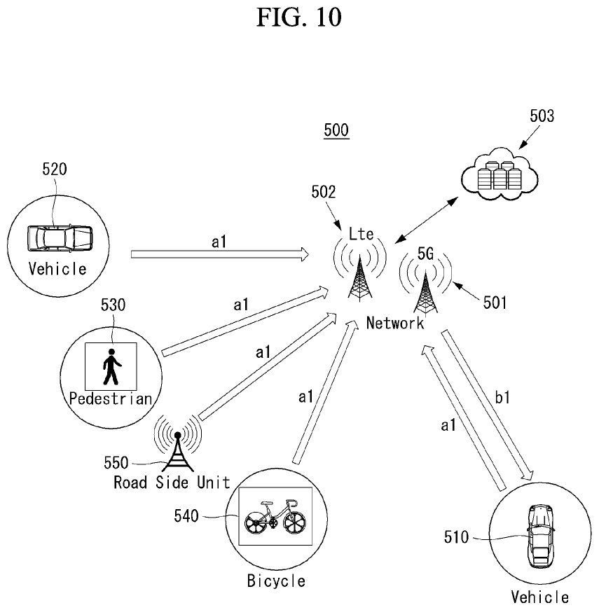

Hereinafter, with reference to FIGS. 10 to 12, a method and a system for determining the driving mode and path considering a communication environment according to an embodiment of the present invention will be described.

A V2X device according to the present invention is a device capable of executing vehicle-to-everything data communication. In the present invention, the V2X device may be mounted on a vehicle which is transportation means and may be mounted on a user terminal which uses a data communicable device. The user terminal may be a user terminal such as a smart phone which can execute mobile communication and in which the V2X device is built-in. However, the V2X device is included even when the V2X device is mounted on a non-motorized vehicle such as a bicycle, and a roadside data transmission/reception device, that is, a road side unit (RSU) is also included in the V2X device. As a result, all entities capable of executing data communication with each other via wireless network communication without being limited to the vehicle may be included in the V2X device according to the present invention. Meanwhile, in the present invention, a plurality of V2X devices are provided. In order to distinguish the respective V2X devices, each V2X device may be referred to first, second, third, fourth, and fifth devices.

Accordingly, hereinafter, for convenient explanation, as shown in FIG. 10, an exemplification is described in which devices (510, 520, 530, 540, 550) including the V2X device capable of implementing a driving mode determined by the method for determining the driving mode and path considering the communication environment according to the present invention correspond to vehicles 510 and 520 capable of executing autonomous driving, a smart phone which is a user terminal capable of executing data communication with the vehicles and is carried by a pedestrian 530, a bicycle 540 on which the V2X device is mounted, or a roadside data communication unit (RSU) 550. Moreover, the vehicles 510 and 520 may be classified into a first vehicle 510 and a second vehicle 520, and the vehicles may be collectively referred to as a vehicle. In addition, the V2X device included in the first vehicle 510 may be referred to as a first device, and the V2X device included in the second vehicle 520 may be referred to as a second device.

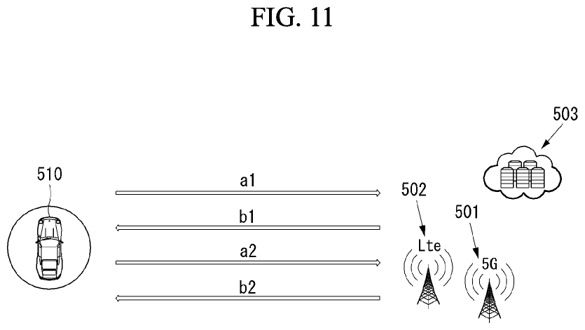

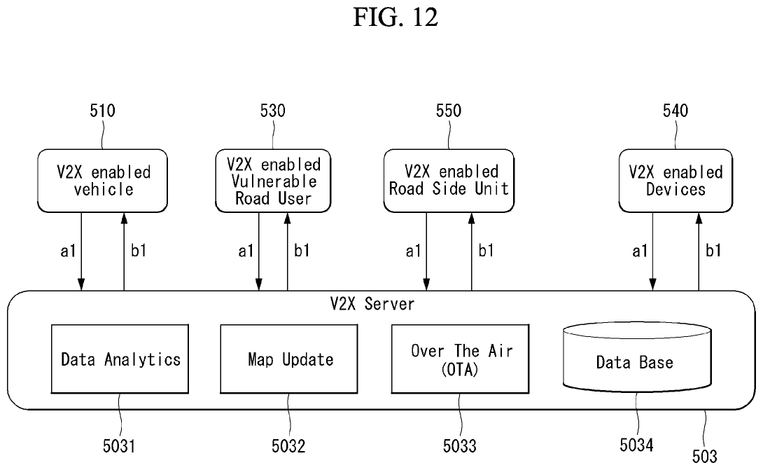

FIG. 10 is a conceptual diagram showing a configuration of a system 500 for determining a driving mode and a path considering a communication environment according to an embodiment of the present invention, FIG. 11 is a conceptual diagram showing a process in which the V2X device performs data communication with a server 503 according to an embodiment of the present invention, and FIG. 12 is a block diagram of the system 500 for determining the driving mode and path considering the communication environment according to an embodiment of the present invention.

First, with reference to FIG. 10, the system 500 for setting the driving mode and path considering the communication environment according to the present invention includes the plurality of devices 510, 520, 530, 540, and 550 each including the V2X device, wireless communication networks 501 and 502, and the server 503. As described above, the plurality of devices 510, 520, 530, 540, and 550 each including the V2X device are implemented as a smartphone owned by the pedestrian 530, the bicycle 540 equipped with the V2X device, and first device and second vehicles 510 and 520 equipped with the V2X device.

Among these, a device capable of implementing the path and driving mode determined by the system 500 for setting the driving mode and path considering the communication environment is exemplified as the first and second vehicles 510 and 520 including the V2X device as a vehicle capable of executing the autonomous driving. However, this is only an example, and when the V2X device is mounted on transportation means similar to a vehicle, the transportation means may perform the driving mode along the path determined by the present invention.

A first device is included in the first vehicle 510 shown in FIG. 10, and a second device is included in the second vehicle 520. Moreover, a third device is included in the smart phone carried by the pedestrian 530, and a fourth device is included in the bicycle 540. In addition, a fifth device is included in the RSU. The first to fifth devices are all capable of performing data communication with each other, and are simultaneously connected to the server 503 through a wireless communication network, for example, a 5G 501 or LTE 502.

When the first to fifth devices perform data communication between the server 503 and other devices using the wireless communication networks 501 and 502, respectively, the server 503 may record and analyze data transmitted and received between devices.

The first to fifth devices perform data communication using a communication technology including the 5G 501 and the LTE 502. In this case, the first to fifth devices may all perform data communication using the same communication technology, or may perform data communication using different communication technologies. For example, the first vehicle 510 including the first device may perform the data communication with the 5G 501 while the second vehicle 520 including the second device may perform the data communication with the LTE 502. In addition, while the first vehicle 510 including the first device performs the data communication with the 5G 501, when the communication environment changes, the first vehicle 510 may perform the data communication with the LTE 502, and vice versa.

The first to fifth devices use the communication technology to transmit geographic information on a current position where each device is currently located and information on the communication technology in service to the server 503 (a1). In addition, each of the first to fifth devices may transmit communication environment information on the communication technology in service to the server 503 (a1). For example, as shown in FIG. 11, the first vehicle 510 may transmit current GPS coordinate information of the first vehicle 510, information on the 5G 501 communication technology being used by the first device included in the first vehicle 510, and the communication environment indicating a state in which the first device currently uses the 5G 501 communication technology to the server 503 through the 5G 501. In addition, the server 503 identifies the 5G communication environment around the first vehicle 510 through the information transmitted from the first device.

The above-described communication environment may be represented as a key performance indicator (KPI), and components constituting the KPI may include all information on a received signal strength indicator (RSSI), a transmission power (Tx power), a signal status, latency, reliability, data throughput, a packet reception rate, a communication range, the number of communication line users, and congestion. The information can be quantified and then averaged to indicate the communication environment.

For example, the server 503 primarily identifies the 5G communication environment around the first vehicle 510 through information on the 5G communication environment collected by the first device, based on a current position of the first vehicle 510 transmitted from the first device. In addition, the server 503 verifies the information on the primarily identified 5G communication environment through the information on the 5G communication environment collected by the third to fifth devices mounted on the pedestrian 530, the bicycle 540, and the RSU 550 located near the first vehicle 510, respectively, and secondarily identifies the 5G communication environment around the first vehicle 510.

The server 503 updates the identified 5G communication environment on an electronic map, at the same time receives information on a destination to which the first vehicle 510 intends to head, and calculates all movable paths from a current position of the first vehicle 510 to the destination on the electronic map. In addition, the server 503 thirdly identifies the 5G communication environment for the entire section of each path in real time using other devices including the V2X devices such as the pedestrian 530, the bicycle 540, and the RSU 550 which exist on the calculated path.

After the server 503 identifies the 5G communication environment for each path, the server 503 selects an appropriate autonomous driving mode for each communication environment formed in each path and transmits the path and the driving mode to the first device of the first vehicle 510 (b1) so that the user can select the path and the driving mode.

In this case, the path provided by the server 503 includes various paths such as an optimal path which provides appropriate communication environment and path for the first vehicle 510 to perform the autonomous driving, the shortest path on which the first vehicle 510 can arrive from the current position to the destination in the shortest time, and a cluster path on which the first vehicle 510 can drive in a cluster together with a vehicle other than the first vehicle 510, for example, the second vehicle 520. The path which can be provided by the server 503 is not limited to the above-described path and more various paths can be provided in the V2X device.

Moreover, the above-described driving mode includes at least one of a manual driving mode, an autonomous driving mode, a cluster driving mode, and a remote driving mode, and the server 503 can provide various driving modes in addition to the above-described modes.

If a user who rides in the first vehicle 510 and wants to go the destination selects one path of various paths provided from the server 503 and selects the driving mode corresponding to the path, the first car 510 starts to drive along the path in the driving mode selected by the user. In this case, the first device included in the first vehicle 510 transmits information on the path and the driving mode selected by the user to the server 503, collects the current position of the first vehicle 510 and data on the KPI index indicating the 5G communication environment at the position at a predetermined time interval (for example, every minute), and transmits the current position and the data to the server 503 (a2).

The server 503 collects the current position information of the first vehicle 510 and the information on the 5G communication environment at the current position transmitted while the first vehicle 510 moves, together with the information on the 5G communication environment transmitted from devices including other V2X devices distributed in the entire section on the path on which the first driver 510 currently drives, compares the communication environment for the entire section on the path with an analysis result (the above-described thirdly communication environment identification step) before the analysis, and continuously determines whether the KPI index indicating the 5G communication environment is improved or degraded.

Moreover, when the KPI index indicating the 5G communication environment is degraded, the server 503 may recommend a path different from the path on which the vehicle is currently driven and a driving mode for the user. That is, when the server 503 determines that the 5G communication environment is bad in a specific section on the path on which the vehicle currently drives, the server 503 generates an alternative path such that the vehicle bypasses the path and drives on another path having a good 5G communication environment, generates an alternative driving mode suitable for driving the corresponding alternative path, and transmits the alternative driving mode to the first device (b2). The first device included in the first vehicle 510 outputs and displays the alternative path and the alternative driving mode recommended by the server 503 so that the user can select the alternative path and the alternative driving mode.

In order to perform the series of steps, as shown in FIG. 12, the server 503 according to the present invention includes a data analytics 5031, a map update 5032, an over the air 5033, and a database 5034.

The data analytics 5031 analyzes, based on data collected from the first device and other devices (second to fifth devices), the communication environment for the communication technology (for example, 5G) being used by the first device in real time at the location at which the first vehicle 510 is currently located, the destination, and the entire section on the path to the destination, and the data analytics 5031 calculates the optimal path and the shortest path from the current position of the first vehicle 510 to the destination thereof. Moreover, the data analytics 5031 generates the driving mode suitable for driving the path based on the communication environment over the entire section on the path, and analyzes and provides an estimated time of arrival to the destination for each path.

For example, when a first communication technology used by the first device included in the first vehicle 510 is the 5G communication technology, in order to analyze the 5G communication environment for the entire section on the path on which the first vehicle 510 will drive, the data analytic 5031 according to the present invention comprehensively considers the KPI information received from other devices different from the first device distributed on the path, the position of the first device, and a current state (device failure and normal operation) of the first device.

In addition, the data analytics 5031 updates a result obtained by analyzing the 5G communication environment for each path to the electronic map and recommends the driving mode most suitable for the communication environment formed in the path so as to correspond with the driving model to be recommended for each path. The path generated by the data analytics 5031, the recommended driving mode for the path, and the communication environment analysis result data are all stored in the database 5034 and simultaneously transmitted to the first to fifth devices.

The map update 5032 updates the communication environment analyzed by the data analytics 5031 to the electronic map, and the over the air (OTA) 5033 serves as a communication unit which transmits the electronic map updated through the map update 5032 and the analyzed data generated by the data analytics 5031 to the first to fifth devices.

The analyzed data generated by the data analytics 5031, analyzed result data obtained by analyzing the communication environment for each path, the electronic map updated by the map update 5032, and current positions of the first to fifth devices are stored in the database 5034.

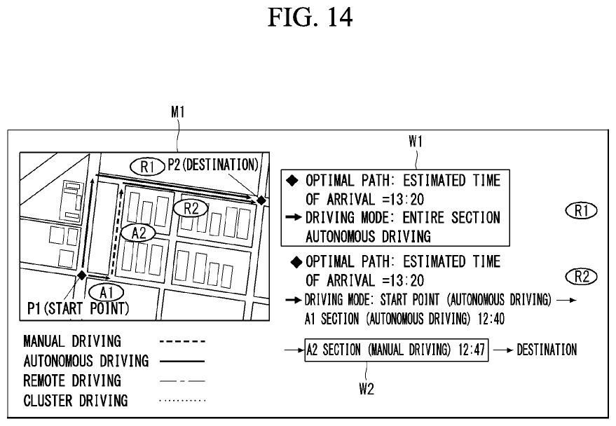

Moreover, the first device according to the present invention further includes an output unit capable of outputting a sound and performing display in order to display the path and the driving mode provided from the server 503. Accordingly, the output unit may include a speaker and a display panel. The first device according to the present invention may guide, by voice, the path and the driving mode provided by the server 503 through the speaker, and as shown in FIG. 14, the display panel may display information on the optimal path, the shortest path, the driving mode recommended for each path, and the estimated time of arrival to the destination, provided by the server 503 in a navigation screen manner.

In this way, the system 500 for determining the driving mode and path considering the communication environment according to the present invention analyzes the communication environment for the entire section on the path on which the vehicle equipped with the V2X device will travels, by integrating the data transmitted from the vehicle equipped with the V2X device and the data transmitted from other V2X devices distributed in the entire section on the path and analyzing the data in real time. Accordingly, the vehicle equipped with the V2X device can quickly cope with a change in quality of the communication environment so as to change the driving mode and path, and thus, the user can use more safe and conformable autonomous driving.

Moreover, when one alternative path and one alternative driving mode recommended by the server 503 are provided, the first device according to the present invention determines that the user cannot select other alternative paths and alternative driving modes, and self-selects the provided one alternative path and one alternative driving mode instead of the user if necessary. Here, “if necessary” includes a case where even when one alternative path and one alternative driving mode are provided by the user, the alternative path and the alternative driving mode are not selected, and a case where the provided alternative driving mode is only the manual driving mode.

In this case, the first device may output an alarm or warning that promotes the user to select the alternative path and the alternative driving mode, and when the user does not select the alternative path and the alternative driving mode even by the warning, the first device directly controls the first vehicle.

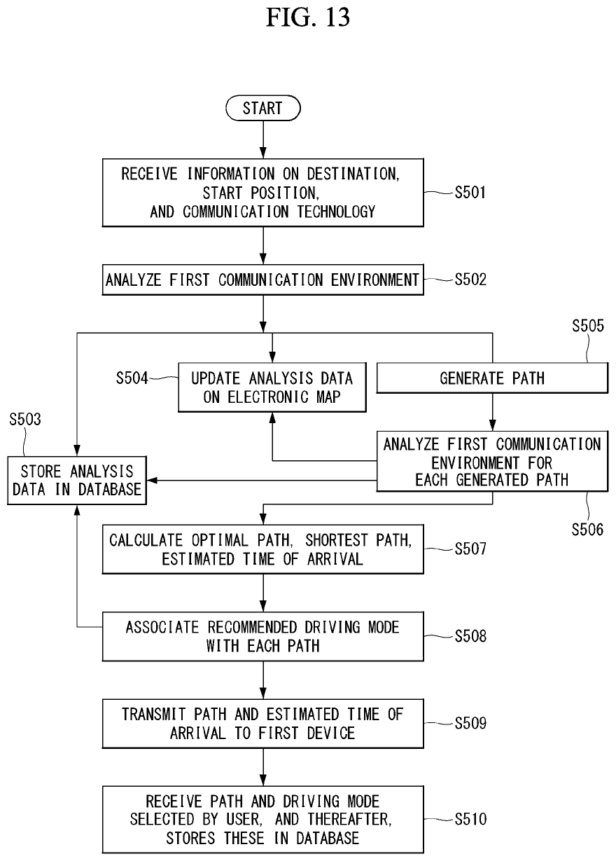

Hereinafter, with reference to FIGS. 13 to 24, a method of analyzing the communication environment using the system 500 for determining the driving mode and path and setting the driving mode and path according to the present invention will be described.

FIG. 13 is a flow chart showing a method in which the server determines the driving mode and path considering the communication environment according to an embodiment of the present invention, and FIG. 14 is a diagram showing an example of a method in which the V2X device displays the path and driving mode selected by the user on the navigation screen according to an embodiment of the present invention.

Hereinafter, at least one of the plurality of V2X devices is referred to as the first device, and another device is referred to as the second device. Meanwhile, as described above and shown in FIG. 1, the first and second devices are the V2X devices included in the first and second vehicles 510 and 520, respectively, and other V2X devices are the third to fifth devices and V2X devices which are included in the user terminal of the pedestrian 530, included in the bicycle 540, or implemented as the RSU 550.

Moreover, as described above, the first and second vehicles 510 and 520 respectively correspond to a vehicle capable of performing the autonomous driving by the first and second devices, and the first and second vehicles 510 and 520 may be collectively referred to as a vehicle.

First, with reference to FIGS. 13 and 14, before the user who rides on the first vehicle 510 starts to a destination (P2, refer to FIG. 14), the user inputs position information on the destination to the first device at a starting point (P1, refer to FIG. 14). If the destination position information is input to the first device by the user, the first device transmits the destination position information, a starting position of the first vehicle 510 and a type of the communication technology being used by the first device to the server, and the server receives these (S501). In this case, as described above, the type of the communication technology includes all communication standard services of the LTE and 5G.

The first device may be constituted to be interlocked with a navigation or a head-up-display (HUD) mounted on the first vehicle 510 and the user may perform an input to the navigation or the HUD instead of the input to the first device.

First, if the communication environment of the communication technology being used by the first device is referred to as a first communication environment, the server 503 analyzes the first communication environment through information transmitted from the first device at a start position of the first vehicle 510 (S502).

For example, when the communication technology being used by the first device is the 5G communication technology, the server 503 can primarily analyze the first communication environment for the 5G communication technology at the current position of the first vehicle 510 using the KPI index for the 5G communication technology collected by the first device (S502).

The server 503 digitizes each information such as the received signal strength indicator (RSSI), the transmission power (Tx Power), the signal status, the latency, reliability, the data throughput, a packet reception rate, a range, the number of communication line users, and the congestion included in KPI, and can analyze the first communication environment using an average value thereof.

In addition, the server 503 verifies the information on the first communication environment primarily identified, through the information on the first communication environment collected by the third to fifth devices mounted on the pedestrian 530, the bicycle 540, the RSU 550 located near to the first vehicle 510, and secondarily analyzes the first communication environment near the first vehicle 510 (S502).

The server 503 stores a result obtained by analyzing the first communication environment in the database (S503), updates the electronic map (S504), and calculates all movable paths from a current position (starting point, P1) of the first vehicle 510 to the destination P2 on the electronic map based on the received information on the destination P2 (S505).

In addition, the server 503 thirdly analyzes the first communication environment in real time for the entire section of each path, using other devices including the V2X device such as the pedestrian 530, the bicycle 540, and the RSU 550 existing on the calculated path (S506). A result obtained by thirdly analyzing may be fed back to the result obtained by primarily analyzing, may be stored in the database, and may be updated on the electronic map at the same time.

The server 503 calculates an optimal path R1 and the shortest path R2 of all paths movable from the starting point P1 to the destination P2 using the result obtained by thirdly analyzing the 5G communication environment, and calculates the estimated time of arrival to the destination for each path (S507).

For example, as shown in FIG. 14, the server 503 calculates, as the optimal path R1, a path on which the first vehicle 510 can perform the 5G communication at a level or more satisfying performance requirements based on 3GPP 22.816 through the first device using the result obtained by thirdly analyzing the first communication environment, and even when some sections which does not satisfy the performance requirements based on the 3GPP 22.816 are included, the server 503 calculates the shortest path R2 in which a distance from the starting point P1 to the destination P2 is calculated as the shortest distance (S507).

Moreover, the server 503 selects an appropriate driving mode for each of the calculated paths R1 and R2 and may associate each path with a recommended driving mode (S508). For example, the optimal path R1 is a path constituted by only sections in which the 5G communication can be smoothly performed, and thus, when the vehicle drives the path, the server 503 may recommend the autonomous driving mode. However, as shown in FIG. 14, in the shortest path R2, a partial section A1 provides the communication environment in which the autonomous driving can be performed. However, another section A2 provides the communication environment in which the autonomous driving is not easily performed, and thus, the shortest path R2 includes a section in which the manual driving should be performed. Accordingly, other driving modes (for example, the autonomous driving in the A1 section, and the manual driving mode in the A2 section) may be recommended for each of the sections A1 and A2.

The server 503 calculates the optimal path R1 based on the result obtained by analyzing the communication environment in this way. In the present invention, the optimal path means a path optimal to perform the autonomous driving based on a road traffic condition and a communication situation for the communication technology being used by the first device, and here, the autonomous driving includes remote driving, cluster driving, and autonomous driving in which the first vehicle 510 self-drives without intervention of the user.

The server 503 may store the calculated optimal path R1, the shortest path R2, a time from the starting point P1 to the destination P2 according to each path, and the estimated time of arrival to the destination P2 for each path in the database 5034 (S509), and the server 503 transmits the optimal path R1, the shortest path R2, the recommended driving mode for each path, and the estimated time of arrival to the first device (S509).

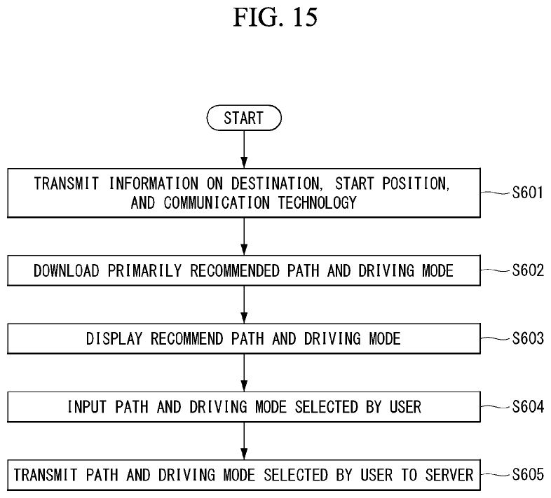

Meanwhile, as shown in FIG. 15, the first device interacts with the server 503. FIG. 15 is a flow chart showing a method in which the V2X device determines the path and driving mode considering the communication environment according to an embodiment of the present invention.

If the first device receives the information on the destination from the user, the first device transmits the communication technology being used by the first device and information on the start position P1 and the destination P2 of the first device to the server (S601).

Thereafter, primarily recommended paths, the estimated time of arrival to the destination for each primarily recommended path, and the driving mode corresponding to each of the primarily recommended paths are downloaded in the server 503 (S602), and the downloaded those are displayed for the user through the output unit of the first device (S603).

Thereafter, if the user inputs a path selected from the primarily recommended paths and a driving mode corresponding to the selected path (S604), the path selected by the user and the selected driving mode are transmitted to the server 503 (S605).

When the server 503 updates the result obtained by analyzing the first communication environment on the electronic map in the above-described Step S506, in Step S602, the first device can download the electronic map updated from the database 5034 of the server 503.

This electronic map may be an electronic map which is stored in the database 5034 included in the server 503 in advance. However, the electronic map is not limited thereto, and may be an electronic map in which the server 503 updates the result obtained by analyzing the first communication environment on the electronic map stored in the database 5034 included in other servers.

For convenience of explanation, the above-described steps are described by classifying the server 503 and the V2X device which is the user terminal. However, in the steps described in FIGS. 13 and 15, correlated steps may be sequentially or simultaneously performed.

When the first device downloads the electronic map updated by the result obtained by analyzing the first communication environment from the server 503, the optimal path R1, the shortest path R2, and the estimated time of arrival to the destination P2 for each path are displayed on the updated electronic map. For example, as shown in FIG. 14, the first device can display the optimal path R1, the shortest path R2, and the estimated time of arrival to the destination P2 for each path on the electronic map having updated information on the first communication environment in a navigation method through a display panel included in the output unit (S603).

As shown in FIG. 14, when these are displayed in the navigation method, the starting point P1, the destination P2, the optimal path R1, and the shortest path R2 are displayed on the electronic map M1 having the updated information on the first communication environment, sections included in each path may be classified by color, and thus, it is possible to classify whether the autonomous driving is performed or the manual driving is performed. Moreover, classifications for the optimal path R1 and the shortest path R2, and the recommended driving mode and the estimated time of arrival to the destination corresponding to each path may be displayed on a side surface of the electronic map M1 in text.

Particularly, when these are displayed in the navigation method, as shown by a first window W1 in the FIG. 14, the estimated time of arrival and the driving mode can be displayed together in text, and when the user uses the path, it can be clearly recognized which driving mode is recommended.

In addition, when it is necessary to change the driving mode for each section included in each path, as shown by a second window W2, a time point at which driving in the section ends is displayed in text so that the user can identify in advance a time point at which the driving mode needs to be changed.

The user checks the paths and the driving modes displayed through the output unit of the first device, and thus, the user can select desired path and driving mode. In this case, if the path and driving mode selected by the user are input to the first device (S604), the first device transmits information on the selected path and the selected driving mode to the server 503 (S605), and the server 503 can store the path and driving mode selected by the user in the database 5034 in log (S510).

Hereinafter, a process will be described, in which the alternative path and the alternative driving mode are provided from the server to the vehicle being driven, according to a change in the communication environment.

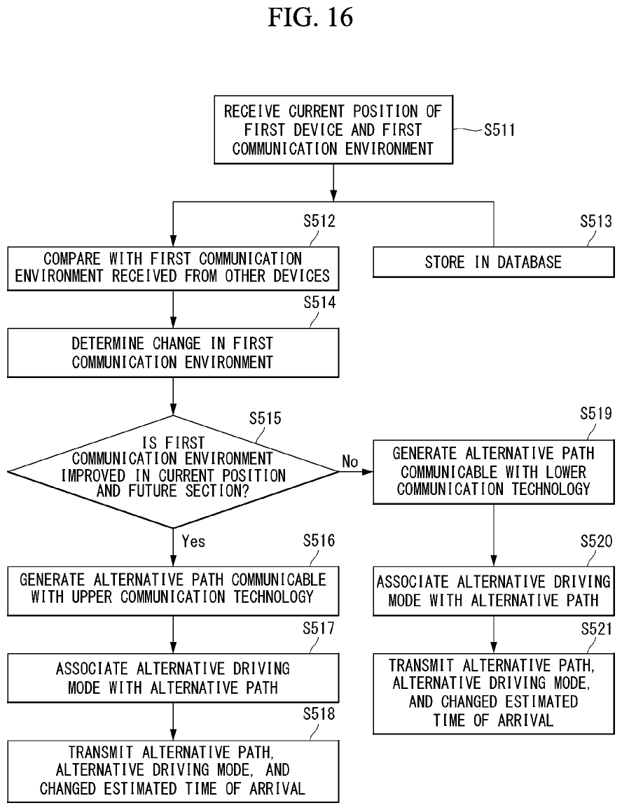

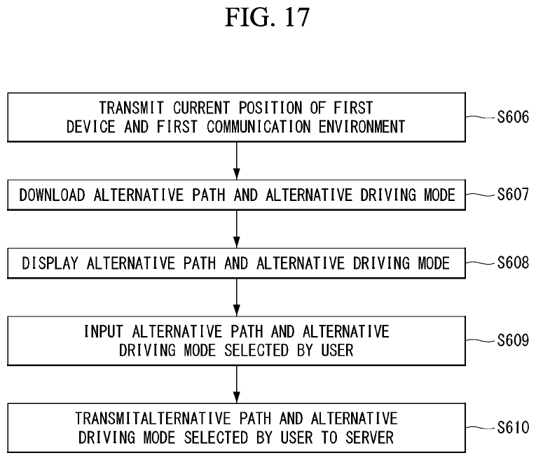

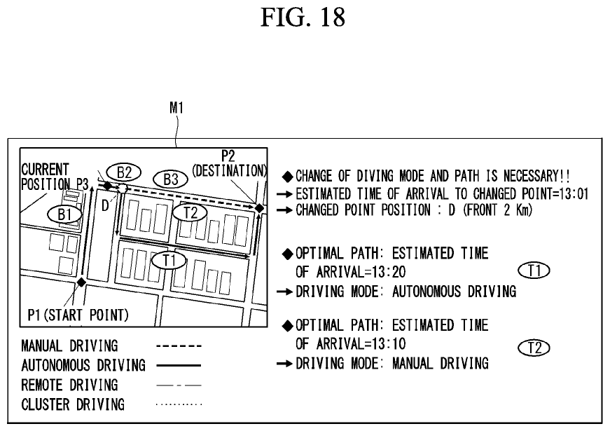

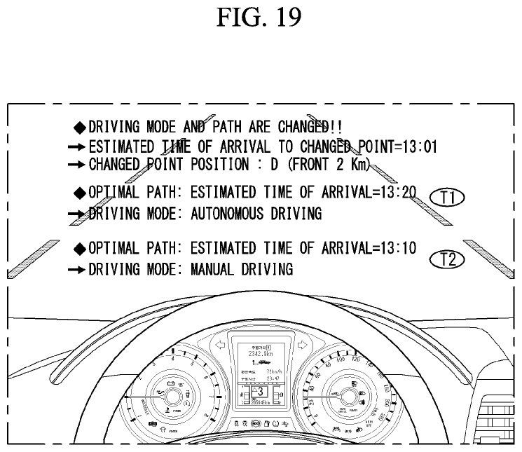

FIG. 16 is a flow chart showing a process in which the server detects the change in the communication environment and provides changed path and driving mode to the V2X device according to an embodiment of the present invention, FIG. 17 is a flow chart showing a process in which the V2X device detects the change in the communication environment and provides the changed path and driving mode to the V2X device according to an embodiment of the present invention, FIG. 18 is a diagram showing an example of a method in which the V2X device displays a need to change the path and driving mode on a navigation screen for the user according to an embodiment of the present invention, and FIG. 19 is a diagram showing an example of a method in which the V2X device displays the need to change the path and driving mode on an HUD screen for the user according to an embodiment of the present invention.

With reference to FIG. 16, if the first vehicle 510 starts driving from the starting point P1 toward the destination P2 according to the path and driving mode selected by the user, the server 503 receives, at a predetermined time interval, a current position P3 (refer to FIG. 17) (in this case, the current position P3 is shown at a position different from the position of the starting point P1) of the first device, first communication environment information (for example, 5G communication environment) on the communication technology at the current position P3, and information on the driving mode being used by the first vehicle 510 at the current position P3, from the first device (S511).

In this case, a time schedule or a predetermined time interval at which the first device transmits the information on the current position and the first communication environment to the server 503 can be variously set. For example, after the first vehicle 510 starts to drive, the above-described third information may be set to be transmitted to the server 503 every one minute, or the third information may be set to be transmitted to the server 503 every ten seconds which are shorter than one minute.

The server 503 can compare information on the first communication environment at the received current position P3 of the first device with the first communication environment information being received in real time from the second to fifth devices distributed on the path and check these (S512). In addition, the server 503 can store information on the first communication environment transmitted from the first device in real time in the database (S513).

The server 503 reanalyzes, based on the comparison result in Step S512, the first communication environment around the first vehicle 510 at the current position P3 of the first vehicle 510 and the first communication environment of the section in which the first vehicle 510 will drive, and monitors the change of the communication environment for each section included in the entire path (S514).

For example, when a first V2X device uses the LTE communication technology, the first communication environment means the communication environment for the LTE communication technology, and as shown in FIG. 17, while the first vehicle 510 moves the starting point P1 to the current position P3, the server 503 receives information on the first communication environments in B1 and B2 sections transmitted through the first device (S511). Moreover, the server 503 additionally collects information on the first communication environments of the B1 and B2 sections from other second to fifth devices distributed in the B1 and B2 sections, and may compare this information with the first communication environment information received in Step S511 (S512). Accordingly, the server 503 can continuously monitor the change in the first communication environments in the B1 and B2 sections (S514).

Based on result monitored in Step S514, the server 503 can determine whether the first communication environments in the B1 and B2 sections are improved (S515) and can determine the first communication environment for the current position P3 of the first vehicle 510 (S515).

For example, the server 503 analyzes the LTE communication environments in the B1 and B2 sections, and as a result, when the LTE communication environments in the B1 and B2 sections satisfy or exceed the performance requirements based on the 3GPP 22.816 (S515), the server 503 can calculate the alternative paths communicable with the 5G communication technology which is the communication technology higher than the LTE (S516). Moreover, the server 503 generates the alternative driving modes usable for each alternative path newly generated and associates the alternative driving modes with the corresponding alternative paths (S517), and recalculates an estimated time of arrival changed for each corresponding alternative path (S517). The alternative path, the alternative driving mode, and the changed estimated time of arrival generated in this way are transmitted to the first device by the server 503 (S518).

Meanwhile, on the contrary, when the first device uses the 5G communication technology, the first communication environment means the communication environment for the 5G communication technology. The server 503 analyzes the 5G communication environments in the B1 and B2 sections, and as a result, when the first communication environments in the B1 and B2 sections do not satisfy the performance requirements based on the 3GPP 22.816 (S515), the server 503 can calculate the alternative paths communicable with the 5G communication technology which is the communication technology lower than the 5G (S519).

Moreover, the server 503 generates the alternative driving modes usable for each alternative path newly generated and associates the alternative driving modes with the corresponding alternative paths (S520), and recalculates an estimated time of arrival changed for each corresponding alternative path (S521). The alternative path, the alternative driving mode, and the changed estimated time of arrival generated in this way are transmitted to the first device by the server 503 (S522).

Meanwhile, with reference to FIG. 17, the first device downloads the alternative path, the alternative driving mode, and the changed estimated time of arrival from the server 503 according to the embodiment (S606), the first device displays the alternative path, the alternative driving mode, and the changed estimated time of arrival through the output unit (S607).

An example in which the first device displays the alternative path, the alternative driving mode, and the changed estimated time of arrival in a navigation screen method is shown in FIG. 18.

First, while the first vehicle 510 starts from the starting point P1 and drives the B2 section through the B1 section, the first vehicle 510 transmits the position information on the current position P3, the first communication environment information (for example, 5G communication environment) for the communication technology at the current position P3, and the information on the driving mode being used by the first vehicle 510 at the current position P3 to the server 503 (S606).

Based on data obtained by analyzing the information on the first communication environments collected in the B1 and B2 sections, the server 503 can determine the communication environment at the current position P3 of the first vehicle 510 (S514) and can determine that the 5G communication environment does not satisfy the performance requirements based on 3GPP 22.816 in all sections from a D point included in the B2 section to a B3 section (S515).

In this case, the server 503 can generate T1 and T2 which are the alternative paths communicable with the LTE communication technology which is the communication technology lower than the 5G (S519). In addition, the server 503 also recalculates an alternative driving mode and an estimated time of arrival to the destination corresponding to each of the newly generated paths T1 and T2 (S520).

The alternative paths T1 and T2 calculated in this way are displayed by arrows on the electronic map M1 shown in FIG. 18, and the estimated time of arrival and the alternative driving mode for each path can be displayed on the side surface of the electronic map M1 in text. In addition, the driving mode corresponding to each alternative path can be classified by a color of an arrow.

Accordingly, the user can select one alternative path of the alternative paths T1 and T2 output through the output unit of the first device and a driving mode corresponding to the alternative path.

FIG. 19 shows an example in which the first device displays the alternative path, the alternative driving mode, and the changed estimated time of arrival on the HUD.

In this way, the user can select one path and one driving mode of the alternative paths and the alternative driving modes displayed in the navigation method or the HUD method, and if the alternative path and the alternative driving mode selected by the user are input to the first device (S609), the first device transmits the alternative path and the alternative driving mode selected by the user to the server 503 (S610), and the server 503 can store the selected alternative path and alternative driving mode in the database in log.

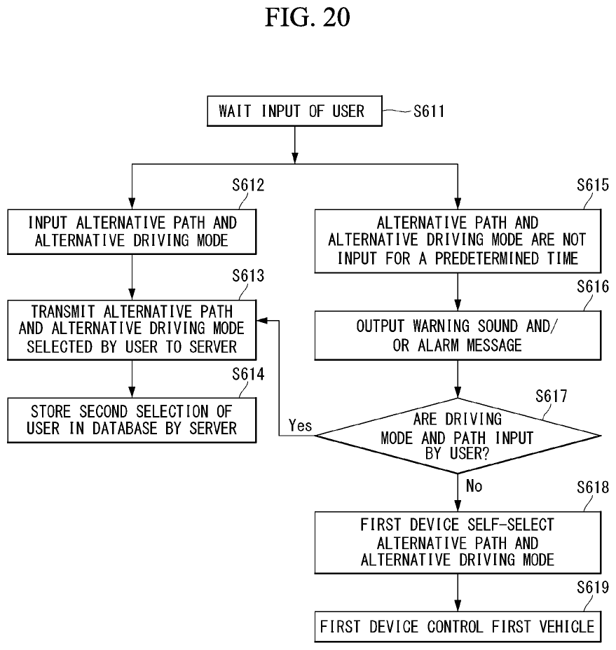

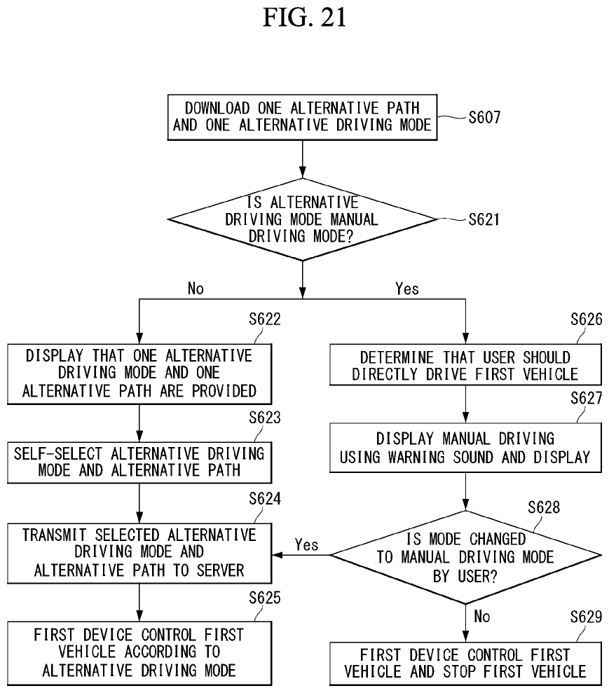

Meanwhile, when the user does not select the alternative path and alternative driving mode supplied by the server 503, the V2X device according to the present invention itself may select the alternative path and alternative driving mode if necessary and control the first vehicle 510. Hereinafter, with reference to FIGS. 20 and 21, embodiments thereof will be described.

FIG. 20 is a flow chart showing a corresponding process of the V2X device according to an input of the user according to an embodiment of the present invention, and FIG. 21 is a flow chart showing a corresponding process of the V2X device in a scenario having one alternative path and one alternative driving mode provided by the server according to an embodiment of the present invention.

As shown in FIG. 20, if the alternative paths provided from the server 503 and the driving mode corresponding to each path are displayed, the first device waits until the user selects the path and the driving mode (S611). In this case, if the user selects the alternative path and the alternative driving mode within a predetermined waiting time (for example, a waiting time of one minute) and inputs these to the first device (S612), the first device transmits the alternative path and the alternative driving mode selected by the user to the server 503 (S613), the server 503 stores the information on the alternative path and the alternative driving mode selected by the user in the database 5034 in log (S614).

However, when the predetermined waiting time (for example, the waiting time of one minute) elapses without the input of the user to the first device (S615), the first device may output a warning sound or an alarm message through the output unit (S616). After the warning sound or the alarm message is output, if the user selects the alternative path and the alternative driving mode and inputs the selected these to the first device (S617), the first device transmits the information on the alternative path and the alternative driving mode selected by the user to the server 503 (S613), and the server 503 stores the information on the alternative path and the alternative driving mode selected by the user in the database 5034 in log (S614).

However, after the first device outputs the warning sound or the alarm message through the output unit (S616), when the user does not select the alternative path and the alternative driving mode, the first device self-selects the alternative path providing the first communication environment satisfying the performance requirements based on the 3GPP 22.816 and selects the alternative driving mode corresponding to the alternative path (S618). Thereafter, the first device controls the first vehicle 510 to move to the destination in the alternative driving mode (S619). In this case, the alternative driving mode may be an autonomous driving type and may include the autonomous driving mode, the remote driving mode, and the cluster driving mode.

Meanwhile, in Step S516 or S519, when only one alternative path generated by the server 503 and one alternative driving mode corresponding to the alternative path are provided, the flow proceeds along the flow chart shown in FIG. 21.

First, the first device downloads one alternative path generated by the server 503 and one alternative driving mode corresponding to the alternative path (S607), and determines whether one alternative driving mode corresponds to the manual driving mode (S621).

If the first device determines that one alternative driving mode does not correspond to the manual driving mode, the first device outputs a message or a sound output informing that only one alternative path and only one alternative driving mode are provided by the server 503 (S622). Moreover, the first device self-selects the alternative path and the driving mode corresponding to the path (S623), and transmits the information on the alternative path and the alternative driving mode selected by the first device to the server 503 (S624). Thereafter, the first device controls the first vehicle 510 and moves to the destination in the selected alternative driving mode (S625). In this case, the alternative driving mode may be an autonomous driving type and may include the autonomous driving mode, the remote driving mode, and the cluster driving mode.

However, if the first device determines that one alternative driving mode provided by the server 503 is the manual driving mode, as shown in FIG. 21, the first device determines that the user should directly drive the first vehicle 510 (S626), the first device outputs through the output unit that the user should drive directly (S627). In this case, it is preferable that the output sound is constituted by a warning sound, and it is preferable that the warning message is output to the display panel.

When the user converts the driving mode into the manual driving mode within a predetermined time (for example, one minute or more) after the first device outputs the warning sound or warning message through the output unit (S627), the first device transmits the information that the driving mode is changed to the manual driving mode to the server (S624), and the user directly controls the first vehicle 510.

However, the manual operation of the user to the first vehicle 510 is not recognized within a predetermined time (for example, one minute or more) after the first device outputs the warning sound or warning message through the output unit (S628), the first device directly controls the first vehicle 510 so as to move the first vehicle to a safe place, and thereafter, stops the first vehicle 510 (S629).

The above-described safe place means a place at which the first vehicle 510 can be safely stopped and includes at least one of a parking lot, a road shoulder, a gas station, a car repair shop, a hospital, and a police station included on the path from the current position P3 to the destination P2.

In this way, in the method for determining the driving mode and path considering the communication environment according to the present invention, the V2X device identifies the change in the communication environment for the used communication technology in real time such that the vehicle being autonomously driven changes the driving mode and path according to the change in the communication environment using the V2X device. Accordingly, more effective autonomous driving or safe driving is realized, and when only one alternative path and only one alternative driving mode are provided, whether the vehicle is controlled via the V2X device is autonomously determined, and thus, convenience and safety of the user are greatly considered. Particularly, in the method for determining the driving mode and path considering the communication environment according to the present invention, when the user does not manually drive in a situation where the manual driving of the user is necessary, the server and the V2X device included in the system for determining the driving mode and path are actively applied to the vehicle control such that the vehicle moves to the safe place, and thereafter, is stopped, and thus, the safety of the user is greatly considered.

### Embodiment 1

A method for determining a driving mode and a path considering a communication environment, the method comprising: receiving first data about a communication technology being used by a first device of a plurality of V2X devices and a start position of the first device transmitted from the first device such that a server for determining a driving mode and a path considering the communication environment determines the driving mode and path; calculating a plurality of paths of the first device to a destination; receiving, in real time, second data about a communication technology being used by each device of the plurality of V2X devices distributed on the plurality of paths except for the first device and a current position of each device; analyzing a first communication environment over the entire section for each of the plurality of paths using the second data; providing primarily recommended paths of the plurality of paths in which a numerical value of a result obtained by analyzing the first communication environment is a predetermined numerical value or more, an estimated time of arrival to the destination for each of the primarily recommended paths, and an driving mode corresponding to each primarily recommended path to the first device; and receiving, from the first device, first user information including a path selected by a user and a driving mode corresponding to the selected path, wherein the first communication environment is represented by converting a key performance indicator (KPI) of a communication technology being used by the first device into a numerical value.

### Embodiment 2

The method of Embodiment 1, wherein the driving mode includes at least one of a manual driving mode, an autonomous driving mode, a cluster driving mode, and a remote driving mode.

### Embodiment 3

The method of Embodiment 2, wherein the analyzing of the first communication environment further includes associating a path of the plurality of paths satisfying performance requirements based on 3GPP 22.816 with at least one of the autonomous driving mode, the cluster driving mode, and the remote driving mode.

### Embodiment 4

The method of Embodiment 2, wherein the primarily recommended paths include at least one of the shortest path and an optimal path, the optimal path is a path on which the first device is movable from the start position to the destination in at least one of the autonomous driving mode, the cluster driving mode, and the remote driving mode, and the shortest path indicates a path in which a distance from the start position to the destination is the shortest.

### Embodiment 5

The method of Embodiment 1, wherein the analyzing of the first communication environment further includes updating analysis result data obtained by analyzing the first communication environment and start position information of the first device on an electronic map, and the electronic map includes a first electronic map stored in a database included in the server and a second electronic map stored in an external database.

### Embodiment 6

The method of Embodiment 1, wherein the analyzing of the first communication environment further includes storing analysis result data obtained by analyzing the first communication environment and start position information of the first device in the database, and the database includes a database included in the server and an external database separated from the server.

### Embodiment 7

The method of Embodiment 1, further comprising: after the receiving of the first user information, receiving a current position of the first device and third data for the first communication environment at the current position of the first device, in real time from the first device; checking the second data being received in real time; and reanalyzing, based on the checked second data and third data, a section including the current position of the first device and a first communication environment for a next section to which the first device moves, in a path primarily selected by the user.

### Embodiment 8

The method of Embodiment 7, further comprising: after the reanalyzing, generating, when a numerical value for the analysis result of the first communication environment is a predetermined numerical value or less, an alternative path having the first communication environment satisfying performance requirements based on 3GPP 22.816 between the destination and the current position of the first device; determining an estimated time of arrival changed according to the alternative path and an alternative driving mode corresponding to the alternative path; and transmitting the alternative path, the estimated time of arrival changed according to the alternative path, and the alternative driving mode to the first device.

### Embodiment 9

The method of Embodiment 8, wherein the generating of the alternative path further includes, when the generated alternative path includes only one first alternative path, determining an estimated time of arrival changed according to the first alternative path and a first alternative driving mode corresponding to the first alternative path, requesting, through the first device, to inform the user that only the first alternative path is provided, and transmitting the first alternative path, the estimated time of arrival changed according to the first alternative path, and the first alternative driving mode to the first device.

### Embodiment 10

The method of Embodiment 9, wherein the determining of the first alternative driving mode corresponding to the first alternative path further includes determining that an operation of the user for the first device is required in a case where the first alternative driving mode is manual driving requiring a manual operation of the user, and requesting, through the first device, the operation of the user for the first device.

### Embodiment 11

The method of Embodiment 7, further comprising: after the reanalyzing, generating, when a numerical value for the analysis result of the first communication environment exceeds a predetermined numerical value, secondarily recommended paths satisfying performance requirements based on 3GPP 22.816 between the destination and the current position of the first device; determining an estimated time of arrival changed for each secondarily recommended path and a secondarily recommend driving mode corresponding to each of the secondarily recommended paths; and transmitting the secondarily recommended paths, the estimated time of arrival changed for each secondarily recommended path, and the secondarily recommended driving mode to the first device.

### Embodiment 12

The method of Embodiment 1, wherein the communication technology includes 3G, LTE, and 5G communication standards, as a network communication standard being used by the plurality of V2X devices, and the key performance indicator (KPI) includes transmission/reception signal strength indicator, transmission/reception delay time, a packet reception rate, a range between devices, a range between a device and a network, the number of communication line users, and data on communication line congestion.

### Embodiment 13

A method for determining a driving mode and a path considering a communication environment, the method comprising: transmitting information on a communication technology being used by a first device and information on a starting position and a destination of the first device so that a vehicle including a V2X device communicates with a network or a server using the V2X device as the first device to determine a driving mode and a path; downloading, from the network or the server, primarily recommended paths, an estimated time of arrival to the destination for each of the primarily recommended paths, and a driving mode corresponding to each of the primarily recommended paths; displaying the primarily recommended paths, the estimated time of arrival to the destination for each of the primarily recommended paths, and the driving mode corresponding to each of the primarily recommended paths for a user; receiving an input of first user information including a path selected by the user from among the primarily recommended paths and a driving mode corresponding to the selected path; and transmitting the first user information to the network or the server, wherein among a plurality of paths from the start position to the destination, the primarily recommended paths are paths indicating that a first communication environment represented by converting a key performance indicator (KPI) of a communication technology being used by the first device into a numerical value is a predetermined numerical value or more.

### Embodiment 14

The method of Embodiment 13, wherein the downloading of the driving mode corresponding to each of the primarily recommended paths further includes downloading an electronic map updated with information on the first communication environment.

### Embodiment 15

The method of Embodiment 13, further comprising: after the transmitting of the first user information to the network or the server, starting the vehicle from the start position to the destination; and transmitting a current position of the first device, the first communication environment at the current position, and third data for the driving mode being used to the server at a predetermined time interval.

### Embodiment 16

The method of Embodiment 15, further comprising: downloading, from the server, alternative paths, an estimated time of arrival changed for each of the alternative paths, and alternative driving modes; and displaying the alternative paths, the estimated time of arrival changed for each of the alternative paths, and the alternative driving modes, using sound and display.

### Embodiment 17

The method of Embodiment 16, further comprising: receiving an input of second user information including the alternative path and the alternative driving mode selected by the user; and transmitting the second user information to the server.

### Embodiment 18

The method of Embodiment 16, further comprising: after the displaying using the sound and display, outputting a warning sound when the second user information including the alternative path and the alternative driving mode selected by the user is not input for a first time.

### Embodiment 19

The method of Embodiment 18, further comprising: causing the first device to select one alternative path and one alternative driving mode of the alternative paths and the alternative driving modes when the second user information is not input for a second time after the warning sound is output; and moving the vehicle by a control of the first device.

### Embodiment 20

The method of Embodiment 16, further comprising: when one alternative path and one alternative driving mode are included in the alternative paths and the alternative driving modes, displaying the one alternative path and the one alternative driving mode for the user using sound and display.

### Embodiment 21

The method of Embodiment 20, further comprising: causing the first device to select the one alternative path and the one alternative driving mode; transmitting the one alternative path and the one alternative driving mode selected by the first device to the server; and controlling the first device such that the vehicle moves along the one alternative path and the one alternative driving mode.

### Embodiment 22

The method of Embodiment 20, further comprising: causing the first device to determine that an operation of the user is required in a case where the one alternative driving mode is a manual driving requiring a manual operation of the user, and causing the first device to request the user to change the mode to a manual driving mode, using a warning sound and display.

### Embodiment 23

The method of Embodiment 22, further comprising: after the requesting of the user to change the mode to the manual driving mode, causing the first device to control the vehicle such that the vehicle is stopped at a safe place when an input for selecting the manual driving mode is not detected during a third time, wherein the safe place includes at least one of a parking lot, a road shoulder, a gas station, a car repair shop, a hospital, and a police station included on a path from the current position to the destination.

### Embodiment 24

A system for determining a driving mode and a path considering a communication environment, the system comprising: a plurality of V2X devices; and a server configured to communicate with the V2X devices, wherein the server receives a first communication environment for a communication technology used by a first device of the V2X devices from the first device and the first communication environment from devices other than the first device, analyzes the first communication environment over the entire section on a path from a start portion of the first device to a destination thereof, and provides recommend paths, a driving mode corresponding to each recommended path, and an estimated time of arrival to the destination for each recommended path to a user, and the first communication environment is represented by converting a key performance indicator (KPI) of a communication technology being used by the first device into a numerical value.

### Embodiment 25

The system of Embodiment 24, wherein the server further includes a data analytics configured to analyze the first communication environment and generate the recommended paths, the driving mode, and the estimated time of arrival, a map update configured to update the first communication environment analyzed by the data analytics on an electronic map, an over the air (OTA) configured to transmit the updated electronic map, the recommended paths, the driving mode, and the estimated time of arrival to the first device, and a database configured to store the first communication environment, the recommended paths, the driving mode, and the estimated time of arrival, wherein the communication technology includes 3G, LTE, and 5G communication standards as a network communication standard being used by the plurality of V2X devices, and the key performance indicator (KPI) includes transmission/reception signal strength indicator, transmission/reception delay time, a packet reception rate, a range between devices, a range between a device and a network, the number of communication line users, and data about communication line congestion.

### Embodiment 26

The system of Embodiment 24, wherein the first device further includes an output unit performing a sound output and display.

### Embodiment 27

The system of Embodiment 24, wherein the plurality of V2X devices further include a rod side unit (RSU).

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

According to the method and system for determining a driving mode and path of the present invention, the server analyzes, in real time, the LTE or 5G communication environment using other V2X devices distributed on the path to the destination, and can suggest the driving mode and path suitable for the communication environment to the vehicle being autonomously driven.

In addition, in the method and system for determining a driving mode and path according to the present invention, when the driving mode and path suggested by the user are not selected, the vehicle self-selects the optimal driving mode and path to be self-driven so as to assist the driving of the user.

What is claimed is:

1. A method for determining a driving mode and a path considering a communication environment, the method comprising:
receiving first data about a communication technology being used by a first device of a plurality of V2X devices and a start position of the first device transmitted from the first device such that a server for determining a driving mode and a path considering the communication environment determines the driving mode and path;
calculating a plurality of paths of the first device to a destination;
receiving, in real time, second data about a communication technology being used by each device of the plurality of V2X devices distributed on the plurality of paths except for the first device and a current position of each device;
analyzing a first communication environment over the entire section for each of the plurality of paths using the second data;
providing primarily recommended paths of the plurality of paths in which a numerical value of a result obtained by analyzing the first communication environment is a predetermined numerical value or more, an estimated time of arrival to the destination for each of the primarily recommended paths, and an driving mode corresponding to each primarily recommended path to the first device; and
receiving, from the first device, first user information including a path selected by a user and a driving mode corresponding to the selected path, wherein
the first communication environment is represented by converting a key performance indicator (KPI) of a communication technology being used by the first device into a numerical value.

2. The method of claim 1, wherein the driving mode includes at least one of a manual driving mode, an autonomous driving mode, a cluster driving mode, and a remote driving mode.

3. The method of claim 2, wherein the analyzing of the first communication environment further includes associating a path of the plurality of paths satisfying performance requirements based on 3GPP 22.816 with at least one of the autonomous driving mode, the cluster driving mode, and the remote driving mode.

4. The method of claim 2, wherein the primarily recommended paths include at least one of the shortest path and an optimal path,
the optimal path is a path on which the first device is movable from the start position to the destination in at least one of the autonomous driving mode, the cluster driving mode, and the remote driving mode, and
the shortest path indicates a path in which a distance from the start position to the destination is the shortest.

5. The method of claim 1, wherein the analyzing of the first communication environment further includes updating analysis result data obtained by analyzing the first communication environment and start position information of the first device on an electronic map, and
the electronic map includes a first electronic map stored in a database included in the server and a second electronic map stored in an external database.

6. The method of claim 1, wherein the analyzing of the first communication environment further includes storing analysis result data obtained by analyzing the first communication environment and start position information of the first device in the database, and
the database includes a database included in the server and an external database separated from the server.

7. The method of claim 1, further comprising: after the receiving of the first user information,
receiving a current position of the first device and third data for the first communication environment at the current position of the first device, in real time from the first device;
checking the second data being received in real time; and
reanalyzing, based on the checked second data and third data, a section including the current position of the first device and a first communication environment for a next section to which the first device moves, in a path primarily selected by the user.

8. The method of claim 7, further comprising: after the reanalyzing,
generating, when a numerical value for the analysis result of the first communication environment is a predetermined numerical value or less, an alternative path having the first communication environment satisfying performance requirements based on 3GPP 22.816 between the destination and the current position of the first device;
determining an estimated time of arrival changed according to the alternative path and an alternative driving mode corresponding to the alternative path; and
transmitting the alternative path, the estimated time of arrival changed according to the alternative path, and the alternative driving mode to the first device.

9. The method of claim 8, wherein the generating of the alternative path further includes, when the generated alternative path includes only one first alternative path, determining an estimated time of arrival changed according to the first alternative path and a first alternative driving mode corresponding to the first alternative path,
requesting, through the first device, to inform the user that only the first alternative path is provided, and
transmitting the first alternative path, the estimated time of arrival changed according to the first alternative path, and the first alternative driving mode to the first device.

10. The method of claim 9, wherein the determining of the first alternative driving mode corresponding to the first alternative path further includes determining that an operation of the user for the first device is required in a case where the first alternative driving mode is manual driving requiring a manual operation of the user, and
requesting, through the first device, the operation of the user for the first device.

11. The method of claim 7, further comprising: after the reanalyzing,
generating, when a numerical value for the analysis result of the first communication environment exceeds a predetermined numerical value, secondarily recommended paths satisfying performance requirements based on 3GPP 22.816 between the destination and the current position of the first device;
determining an estimated time of arrival changed for each secondarily recommended path and a secondarily recommend driving mode corresponding to each of the secondarily recommended paths; and
transmitting the secondarily recommended paths, the estimated time of arrival changed for each secondarily recommended path, and the secondarily recommended driving mode to the first device.

12. The method of claim 1, wherein the communication technology includes 3G, LTE, and 5G communication standards, as a network communication standard being used by the plurality of V2X devices, and
the key performance indicator (KPI) includes transmission/reception signal strength indicator, transmission/reception delay time, a packet reception rate, a range between devices, a range between a device and a network, the number of communication line users, and data on communication line congestion.

13. A method for determining a driving mode and a path considering a communication environment, the method comprising:
transmitting information on a communication technology being used by a first device and information on a starting position and a destination of the first device so that a vehicle including a V2X device communicates with a network or a server using the V2X device as the first device to determine a driving mode and a path;
downloading, from the network or the server, primarily recommended paths, an estimated time of arrival to the destination for each of the primarily recommended paths, and a driving mode corresponding to each of the primarily recommended paths;
displaying the primarily recommended paths, the estimated time of arrival to the destination for each of the primarily recommended paths, and the driving mode corresponding to each of the primarily recommended paths for a user;
receiving an input of first user information including a path selected by the user from among the primarily recommended paths and a driving mode corresponding to the selected path; and
transmitting the first user information to the network or the server, wherein
among a plurality of paths from the start position to the destination, the primarily recommended paths are paths indicating that a first communication environment represented by converting a key performance indicator (KPI) of a communication technology being used by the first device into a numerical value is a predetermined numerical value or more.

14. The method of claim 13, wherein the downloading of the driving mode corresponding to each of the primarily recommended paths further includes downloading an electronic map updated with information on the first communication environment.

15. The method of claim 13, further comprising: after the transmitting of the first user information to the network or the server,
starting the vehicle from the start position to the destination; and
transmitting a current position of the first device, the first communication environment at the current position, and third data for the driving mode being used to the server at a predetermined time interval.

16. The method of claim 15, further comprising:
downloading, from the server, alternative paths, an estimated time of arrival changed for each of the alternative paths, and alternative driving modes; and
displaying the alternative paths, the estimated time of arrival changed for each of the alternative paths, and the alternative driving modes, using sound and display.

17. The method of claim 16, further comprising:
receiving an input of second user information including the alternative path and the alternative driving mode selected by the user; and
transmitting the second user information to the server.

18. The method of claim 16, further comprising: after the displaying using the sound and display,
outputting a warning sound when the second user information including the alternative path and the alternative driving mode selected by the user is not input for a first time.

19. The method of claim 18, further comprising:
causing the first device to select one alternative path and one alternative driving mode of the alternative paths and the alternative driving modes when the second user information is not input for a second time after the warning sound is output; and
moving the vehicle by a control of the first device.

20. The method of claim 16, further comprising:
when one alternative path and one alternative driving mode are included in the alternative paths and the alternative driving modes, displaying the one alternative path and the one alternative driving mode for the user using sound and display.
